(19) United States
(12) Patent Application Publication
(10) Pub. No.: US 2024/0158218 A1
(43) Pub. Date: May 16, 2024

(54) FLUIDIC OUTFLOW UNIT AND ASSOCIATED USES

(71) Applicant: Neoperl GmbH, Müllheim (DE)

(72) Inventors: Fabian WILDFANG, Müllheim (DE); Christoph WEIS, Müllheim (DE)

(73) Assignee: Neoperl GmbH, Müllheim (DE)

(21) Appl. No.: 18/282,289

(22) PCT Filed: Feb. 23, 2022
(86) PCT No.: PCT/EP2022/054488

§ 371 Date: Sep. 15, 2023

(30) Foreign Application Priority Data
Mar. 19, 2021 (DE) 202021101419.9

(51) Int. Cl. B67D 1/00

(52) U.S. Cl. CPC B67D 1/0039; B67D 2001/0093; B67D 2210/0006

(57) ABSTRACT

In order to simplify the creation of fluidic outflows in the widest possible range of application situations, a fluidic outflow unit (1) is provided in which fluid flows from various sources (3) are guided via respective flexible connection elements (6) to different discharge elements (4) and/or different flow control elements (5) of the outflow element (1). The use of the flexible connection elements (6) ensures that the outflow unit (1) can be arranged in different installation spaces (14) inside an item of furniture (13) or a sanitary object, in such a way that the installation space (14) itself does not need to form a water duct.

### CROSS-REFERENCE TO RELATED APPLICATIONS

The present application is a 371 National Phase of International Application No. PCT/EP2022/0054488, filed Feb. 23, 2022, which claims priority to German Patent Application No. 20 2021 101 419.9, filed Mar. 19, 2021, both of which are incorporated herein by reference as if fully set forth.

### TECHNICAL FIELD

The invention relates to a fluidic outflow unit which can be used in particular in a piece of furniture or in a sanitary object in order to create a controllable fluid outflow.

The invention therefore also relates to different applications of a fluid outflow unit, in particular in a piece of furniture or a sanitary object, (such as a sanitary fitting).

Finally, the invention also relates to the application of a push-push actuating apparatus for actuating a fluid outflow unit.

### BACKGROUND

In the prior art, for example, jet regulators are common as jet-forming outlet elements of sanitary fittings, which can be screwed into the respective sanitary fitting in order to create a fluidic outlet unit. In this case, the sanitary fitting is then typically designed so as to conduct water (for example made of a metal body) and forms an internal water pipeline for this purpose, the wall of which is formed by the wall of the fitting. This internal water pipeline is then connected to a corresponding water connection for the water supply and thus supplies water to the jet regulator so that said water can finally emerge from the jet regulator as a shaped jet. However, such water pipelines are not flexibly adaptable.

WO 2007/026153 A1 discloses a spray head for a shower, wherein the spray head comprises spray nozzles which are arranged in a multiplicity of groups which are each arranged in such a manner that they receive water from a mixer valve via a corresponding ON/OFF solenoid valve which is accommodated in the spray head.

US 2008/178935 A1 discloses a deflector unit which is configured in such a manner that it can be connected to a water-tap unit which can be installed on a washbasin.

Fluidic outlet units are quite generally required at the widest variety of places and for the widest variety of installations. If the installation situation deviates from a usual standard, so that individual solutions have to be created, it is often very difficult to implement such individual solutions by means of known available products. This means that conventional fluidic outlet units can only be adapted with great effort.

For example, when setting up fluidic outlet units that are to be integrated into pieces of furniture or sanitary objects, it happens time and again that previously known solutions are unsuitable since they cannot be flexibly adapted to a specific existing installation space or a restriction imposed by the installation situation. In particular, when custom-made pieces of furniture are to be designed with a fluidic outlet unit, there is a lack of suitable solutions for equipping the pieces of furniture with a fluidic outflow unit in an individualized and simple manner.

### SUMMARY

Based on this, the object of the invention is to create a technical solution to make fluidic outflow units simpler and more flexible. The aim is also to improve the convenience of handling. In addition, a solution is to be created that enables a greater design variety of the associated piece of furniture/sanitary object as well as new application possibilities of the fluidic outflow unit.

In accordance with the invention, in order to achieve this object, the features of claim 1 are provided in the case of a fluidic outflow unit which can be provided in particular for use in a piece of furniture or in a sanitary object. In particular, it is thus proposed in accordance with the invention for achieving the object in the case of an outflow unit of the type mentioned at the beginning that the outflow unit comprises the following elements: multiple supply lines which can be connected and are connected to respective fluidic sources and are fluidically connected to at least one respective flow control element so as to control a flow from one of the sources to an outlet element of the outflow unit; at least one outlet element; at least one flow control element for controlling a flow from one of the sources to an outlet element of the outflow unit; and at least one connecting element which fluidically connects the at least one outlet element of the outflow unit to the at least one flow control element of the outflow unit.

The outflow unit can comprise both controllable and non-controllable flow control elements, as well as further functional elements (such as heating and cooling elements).

The at least one connecting element and preferably also the supply lines can each be designed to be flexible, for example by each being made of a soft, deformable material (in particular silicone). In this way, it can be achieved that a spatial arrangement of the elements of the outflow unit is reversibly adaptable, i.e. in particular repeatedly changeable. This is advantageous since, on the one hand, it allows the outflow unit to be adapted multiple times during assembly until an ideal spatial arrangement is found (unlike, for example, in the case of the use of bendable metal pipelines, which tend to develop weak points due to material fatigue after repeated bending); on the other hand, it also makes it particularly simple to continue using the outflow unit if the available installation space in which the outflow unit is to be inserted changes in size or shape (for example, in the case of a product or design change). This can save development costs.

In addition, at least one connecting element of the outflow unit can form a fluidic branch in order to realize more complex fluid flows (for example, starting from one source to multiple elements).

A fluid can thus be drawn from one of the sources via a respective outlet element of the outflow unit if a flow control element of the outflow unit is controlled accordingly, for example in order to dispense water, a beverage or another fluid with the aid of the outflow unit. As will be explained, mixtures of fluids from at least two of the sources can also be drawn via an outlet element if the outlet unit is designed accordingly.

With an outflow unit in accordance with the invention, it is therefore possible that a respective fluid flow can be discharged from each of the sources in the form of an outlet jet which is formed by an outlet element of the outflow unit and can be regulated (i.e. in the simplest case can be switched on and off) by means of an assigned flow control element of the outflow unit.

Furthermore, with an outflow unit in accordance with invention, it is also possible for a fluid which is drawn from one of the sources to be discharged from different outlet elements of the outflow unit, in particular also mixed with a fluid from a further one of the sources. Changing the outlet element for this fluid flow can be achieved by accordingly actuating or controlling a flow control element, which can selectively switch a source-side fluid input flow to at least two outlet-side fluidic interfaces (so-called “distributor”). This is useful, for example, if the fluid is to be discharged in different jet shapes or flow rates (each determined by the respective outlet element). The outflow unit can be set up for such functionality by interconnecting the elements according to the desired fluid flow via connecting elements and selecting appropriate flow control elements (switching valves, unifiers, mixers, distributors, etc.).

In other words, the invention thus proposes to assemble the fluidic outflow unit from the above elements (which can preferably be taken from a modular system having a limited number of defined different elements), in each case in a modular manner. By appropriately bending the respective flexible connecting element and/or the preferably also flexibly designed supply lines, the elements can be arranged so flexibly in different geometric arrangements that the outflow unit can be used in a widest variety of installation spaces within a piece of furniture or a sanitary object. In so doing, the flexible connecting elements and supply lines can also be shortened accordingly in order to make any necessary adaptations.

In other words, an outflow unit in accordance with the invention can be characterized precisely by the fact that, when the at least one outlet element is mounted in a fixed position in a wall of a piece of furniture or a sanitary object, the other elements of the outflow unit (i.e. the at least one connecting element, the at least one flow control element and the supply lines) can be arranged in different spatial constellations due to the flexibility of the at least one connecting element (cf. for example the example of FIGS. 2A and 2B for this purpose); accordingly, the other elements of the outflow unit can be flexibly moved within an installation space when the at least one outflow element is mounted in a fixed position and can thus be mounted in a particularly simple manner (for example, in order to guide the manual operating elements through corresponding lead-throughs in the wall). This facilitates the installation of the outflow unit in a widest variety of installation spaces.

Consequently, preferably, only the respective outlet element on the piece of furniture/sanitary object can be inserted into a corresponding lead-through that leads into the installation space in which the fluidic outflow unit is inserted. Furthermore, manual operating elements of the outflow unit which is used to control the flow control elements can also be led out of the installation space to the outside in order to enable a simple manual operation.

A fluidic outflow unit in accordance with the invention provides the advantage that it can be used in a widest variety of installation spaces and can even be adapted if necessary (by rearranging the elements listed above). Characteristic for a fluidic outflow unit in accordance with the invention can thus be that the above-mentioned elements of the outflow unit can be arranged in different geometric constellations to one another. Therefore, a fluidic outflow unit in accordance with the invention can also be used in a particularly simple manner in a widest variety of installation spaces.

According to one embodiment, the at least one outlet element (i.e. in particular each of these multiple outlet elements depending on the embodiment) can form an outlet jet which is defined in the jet shape. Consequently, the corresponding fluid can be made available with a specific fluidic functionality, whereby several different jet shapes can also be formed from the same fluid with the aid of the outflow unit. In this case, it is possible to provide that two outlet elements differ with respect to a jet shape. Thus, an instantaneous jet shape or jet quality can be influenced or adjusted by corresponding actuation of a flow control element.

Alternatively or additionally, the at least one outlet element can also determine a defined through flow (i.e. a specific flow rate in L/min at a given source-side delivery pressure, for example in order to achieve/maintain a specific through flow class).

In this case, it is possible to provide, for example, that two outlet elements differ with respect to a through flow class. Thus, an instantaneous through flow class can be influenced or selected by corresponding actuation of a flow control element.

Alternatively or additionally, the at least one outlet element can comprise a defined temperature profile.

In this case, it is possible to provide, for example, that two sources differ with respect to a temperature. Thus, a variety of different fluids or waters can be increased.

Alternatively or additionally, it can be provided that two outlet elements and/or two flow control elements are designed for different temperatures. For example, synthetic materials that are stable at high temperatures can be selected as the material for the respective outlet element and/or flow control element if, for example, boiling hot water is to be provided with the outflow unit. It is therefore advantageous that special waters such as boiling water or ice-cooled water can be provided. In this case, the outflow unit can also have corresponding cooling and/or heating elements to set a respective fluid temperature. These elements can, for example, be inserted into the respective fluid path from the source to the outlet element as instaneous water heaters or instaneous water coolers.

It is therefore understood that the at least one outlet element can draw a fluid from at least one of the sources (in order to discharge it) via a respective associated flow control element.

In accordance with a preferred embodiment, it is provided that the at least one outlet element forms an outlet jet which is defined in the jet shape, determines a defined through flow and is connected to at least one of the sources via an associated flow control element. This fluidic connection to the source can preferably be realized by means of one flexible connecting element respectively which is arranged between the outlet element and the flow control element or between the flow control element and the source. In this case, further flow control elements or other functional elements can also be connected into the fluid flow between the source and the outlet element (for example if a fluid mixture which is mixed by the outlet unit from fluids from two of the sources is to be discharged).

Accordingly, the outflow unit can preferably comprise multiple flow control elements, each of which can be individually controlled and/or manually operated by means of a manual operating element. By virtue of such designs, it is possible to achieve in particular that each flow of a fluid from one of the fluidic sources can be controlled via a respective flow control element to an outlet element of the outflow unit.

It is particularly favorable for a simplest possible operation if the flow control elements are each uniquely assigned to one of the fluidic sources and/or uniquely assigned to one of the outlet elements. Separate fluidic paths (for example for different waters such as carbonated water, hot water, purified water, etc.) can thus be formed and controlled.

In other words, it is thus possible to achieve in particular that two respective fluid flows from two of the sources respectively issue into a common outlet element or into two separate outlet elements. Depending on the number of sources, both of these variants can also be realized in the outflow unit.

In accordance with the invention, each flow control element is uniquely assigned an outlet element. Thus, a 1:1 correspondence between outlet elements and flow control elements can be realized. Thus, the type or quality of a jet can be identified in a simple manner, for example by marking on the flow control element, on the basis of the associated flow control element.

Furthermore, in certain embodiments, at least two flow control elements of the outflow unit can be fluidically connected to one another, wherein this can preferably be realized via a flexible connecting element. This is useful, for example, if the fluid flows from two sources are to be switched on and off via a respective flow control element and these two fluid flows are to be combined in a further flow control element which is configured as a unifier, for example, in order to supply the mixture of the two fluid flows to a common outlet element (preferably via a further flexible connector).

In the fluidic outflow unit, at least two flow control elements can thus preferably be manually operated and/or controlled. Such an activation can be realized via a fluidic, electrical or pneumatic activation, for example. As a consequence, a widest variety of fluid outflows can be realized using the outflow unit, in particular it is possible to dispense mixed beverages, for example.

In accordance with a particularly preferred embodiment, it is provided that at least one flow control element of the outflow unit, but preferably all manually switchable flow control elements of the outflow unit, can be manually switched in each case by means of a push-push actuating apparatus. By using a push-push actuating apparatus, a particularly convenient operation can be realized so that the respective flow control element can be switched from a first to a second switching state by pressing a manual operating element of the push-push actuating apparatus and from the second switching state back to the first switching state by pressing the manual operating element again.

By providing a push-push actuating apparatus, it is thus possible to realize a particularly convenient mixing of two fluids and/or switching on and off of a fluid flow from one of the outlet elements. For example, the flow control element that can be manually operated via the push-push actuating apparatus can in particular be a flow valve. In this case, the flow valve can be opened, for example, by pressing a manual operating element of the push-push actuating apparatus and then closed by pressing the manual operating element again.

It is preferred that the at least one outlet element of the outflow unit can form a defined outlet jet. In other words, it is preferred that a respective outlet element can be designed in particular as a jet regulator.

In the case of such embodiments, it is moreover advantageous if the fluidic outflow unit comprises functionally different outlet elements or jet regulators which can form the differently formed outlet jets. In this case, it is also possible for example for a fluid flow to be supplied from a specific source by means of a flow control element of the outflow unit of different outlet elements of the outflow unit. As a consequence, one and the same fluid or fluidic mixture can be discharged in different outlet jets by the outflow unit, which increases the convenience, or also new fluidic functions (for example moistening with a fine spray versus washing off with a soft, voluminous shower jet) are possible.

At least one connecting element, but preferably all connecting elements, of the outflow unit can each be designed in a particularly simple manner as a flexible hose, preferably made of synthetic material. This makes it particularly simple to adapt the outflow unit to a widest variety of installation situations, since the hoses can be bent and cut to length in a particularly simple manner.

Accordingly, the supply lines that supply the respective fluid from one of the sources can also each be designed as flexible hoses, preferably likewise made of synthetic material.

A significant advantage of these embodiments is that the fluidic outflow unit can be flexibly inserted into installation spaces of different sizes within a piece of furniture or a sanitary object. In this case, the other elements of the outflow unit can be arranged in different geometric arrangements within a given installation space by appropriately cutting to length and bending the flexible connecting elements.

The multiple sources can be formed, for example, by a respective water connection (for example, a cold water connection and a hot water connection) or a liquid reservoir, in particular a beverage reservoir, and do not necessarily need to belong to the outflow unit.

Therefore, the supply lines can each comprise on the source side a connection piece for the, preferably pluggable, connection of the respective supply line to a respective source. As a result, it is possible to simply replace a respective source, in particular when it is designed as a fluid reservoir (for example, when its fluidic content has been exhausted).

It is preferred that each of the flow control elements of the outflow unit comprises (at least) one source-side fluidic interface and (at least) one outlet-side fluidic interface. This fluidic interface can preferably be coupled or is coupled (in the installation situation) to one of the flexible connecting elements respectively.

In this case, in particular, at least one flow control element of the outflow unit can comprise at least two such fluidic interfaces on the source side or on the outlet side. The reason being that as a result, this flow control element can be set up, for example, as a fluidic unifier/mixer or as a fluidic distributor.

It is particularly preferred in this case (in order to enable a simplest possible redesign/adaptation of the fluidic outflow unit) if the said interfaces are plugged in a fluidically tight manner into respective ones of the flexible connecting elements. These plug-in connections are thus reversible and can be realized as required. This means that different fluidic outflow units in accordance with the invention can thus always be constructed from the same elements.

As already indicated, at least one flow control element of the outflow unit can be arranged/set up as a fluidic unifier or mixer. Such a unifier/mixer will thus comprise (at least) two source-side fluidic interfaces, which fluidically issue into an outlet-side fluidic interface. This fluidic interface can be fluidically connected to a further flow control element or an outlet element.

Alternatively or additionally, it can be provided that an outlet element is designed as such a unifier or mixer. This has the advantage that the different waters do not need to share a common pipeline section up to the outlet element. Mutual interference when the outlet element is used alternately can thus be avoided, since no residues of the waters occur in a jointly used pipeline section.

Furthermore, at least one flow control element of the outflow unit can be arranged/set up as a fluidic distributor (alternatively or additionally). Such a distributor can comprise (at least) one source-side fluidic interface, which fluidically issues into (at least) two outlet-side fluidic interfaces.

According to a further preferred embodiment, all elements of the outflow unit can be fluidically connected to one another in such a flexible manner that the outflow unit, in particular after adapting lengths of individual elements of the flexible connecting elements, can be installed in different shapes.

For example, multiple flexible connecting elements of the outflow unit can supply or discharge fluid in different spatial directions and/or comprise different radii of curvature in a respective installation situation.

The fluidic outflow unit can also comprise further fluidic functional units, such as an instantaneous water heater, a sensor unit (for example temperature measuring unit), an actuator unit (for example fluidic pump) or possibly an electro-fluidic unit (for example fluidic current generator). Such functional units can be interposed—like the flow control elements—in the fluid flow from one of the sources to an outlet element of the outflow unit by means of flexible connecting elements in order to provide additional functionality (for example, the possibility of generating hot water from a cold water source by means of an instantaneous water heater).

In order to achieve the above-mentioned object, it is also proposed to use a fluidic outflow unit in a piece of furniture or in a sanitary object, whereby the outflow unit can be designed in particular as described above or according to one of the claims directed to a fluidic outflow unit. This use of said fluidic outflow unit is characterized by the fact that the outflow unit is inserted in a (particularly half-open) installation space inside the piece of furniture or sanitary object and that at least one outlet element of the outflow unit is connected to a (fluidic) source via at least one (preferably flexible) connecting element. Furthermore, it is provided that the at least one outlet element is inserted into a wall of the piece of furniture/sanitary object which delimits (and thus defines) the installation space.

When said fluidic outflow unit is used, it is preferred if in this case the fluidic outflow unit is arranged in the installation space in such a manner that it cannot be seen from the outside in the specific installation situation—with the exception of the outlet element and any manual operating elements that can be formed.

Moreover, it is proposed in order to achieve the object to use a fluidic outflow unit, which is characterized precisely by the fact that fluids are discharged from the outflow unit at different temperatures. For this purpose, i.e. changing the temperature of the respective fluid, it is possible in this case to use a cooling and/or a heating element of the outflow unit, which is used to control the respective fluid temperature. When such elements are used, the outflow unit can be designed as described above and the features of use described above (with reference to the use of the outflow unit in a piece of furniture or a sanitary object) can also be realized.

It is also possible to provide different temperatures at different sources. This can increase a functional range of the outflow unit.

Finally, in order to achieve the object mentioned at the beginning, the use of a push-push actuating apparatus for controlling (at least) one flow control element of a fluidic outflow unit is proposed. In this case, the outflow unit can preferably be designed as described above or in accordance with one of the claims directed to a fluidic outflow unit. In this case, the push-push actuating apparatus allows switching between two switching states of the actuated flow control element by respectively pressing a manual operating element of the push-push actuating apparatus. This enables a particularly convenient operation of the outflow unit.

It can thus be provided in particular that individual or even all (controllable) flow control elements of the fluidic outflow unit described above are designed as push-push flow control elements, in particular as push-push valves.

The invention will now be described in more detail with reference to exemplary embodiments, but is not limited to these exemplary embodiments. Further embodiments of the invention can be obtained from the following description of a preferred exemplary embodiment in conjunction with the general description, the claims and the drawings.

### BRIEF DESCRIPTION OF THE DRAWINGS

In the following description of various preferred embodiments of the invention, elements which correspond in their function are given corresponding reference numbers even if their design or shape differs.

In the drawings:

FIG. 1 shows a highly schematized functional representation, not to scale, of a first fluidic outflow unit in accordance with the invention, which is arranged inside a piece of furniture,

FIG. 2A shows a highly schematized functional representation, not to scale, of a second fluidic outflow unit in accordance with the invention,

FIG. 2B shows the same outflow unit of FIG. 2A, but with the elements of the outflow unit arranged in a different piece of furniture 13 in a different geometrical arrangement,

FIG. 3 shows an oblique view of a further outflow unit in accordance with the invention which has multiple push-push actuating apparatuses,

FIG. 4 shows a lateral view of the outflow unit of FIG. 3, and

FIG. 5 shows a further outflow unit in accordance with the invention with connected sources, prior to insertion into an inner space.

### DETAILED DESCRIPTION

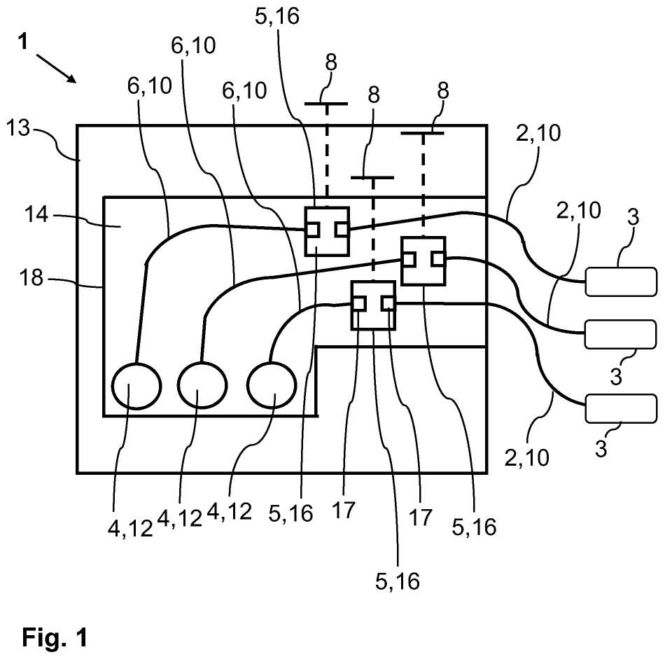

FIG. 1 shows a fluidic outflow unit designated in its entirety as 1, which has three outlet elements 4, for example each designed as a jet regulator 12 and/or a jet former. In this case, the outflow unit 1 is inserted into an installation space 14, which is defined by the inner wall 18 of a piece of furniture 13. In this case, the outlet elements 4 are inserted into the wall 18 so that they can each deliver a fluid to the outside.

The sources 3 in FIG. 1 can, for example, supply various beverages, such as tap water, carbonated water, or soft drinks such as lemonade or fruit juices, or even alcoholic beverages.

Each of the three outlet elements 4 is connected via a dedicated flexible connecting element 6 in the form of a synthetic material hose 10 to a controllable flow control element 5. For this purpose, the respective hose 10 is plugged in a fluidically tight manner into an outlet-side fluidic interface 17 of the respective flow control element 5.

In the same manner, each of the three flow control elements 5 is fluidically connected for its part via a further flexible hose 10, which is used as a respective supply line 2, to a respective source 3 in the form of a fluid reservoir. In this case, each source 3 supplies a different beverage.

The flow control elements 5 are in the case of the example in FIG. 1 each designed as manually operable flow valves 16, in each case having a source-side and an outlet-side fluidic interface 17. Each of these interfaces 17 can be coupled or is coupled to a respective flexible connecting element 6 and in fact by means of a plug connection which is designed in a fluidically tight manner.

Each of the flow valves 16 can be opened and closed via corresponding manual operating elements 8. This allows a respective fluid flow to be switched from the associated reservoir 3 to the respectively assigned outlet element 4. In other words, it is thus possible to draw a beverage from each of the three outlet elements 4 respectively.

Thus, in the example of FIG. 1, each fluid or beverage from the respective source 3 is assigned an associated flow control element 5, so that the fluid outflows from the respective source 3 can be individually adjusted and in fact manually via the respective manual control elements 8. In this case, each of the three flow control elements 5 can be actuated individually and each of the three fluid flows issue into a respective separate outlet element 4.

By virtue of using the flexible connecting elements 6, it is easy to see that the outflow unit 1 which is illustrated in FIG. 1 can also be used in a simple manner in differently shaped installation spaces 14, because the elements 2, 4, 5 and 6 can be arranged in different geometric arrangements, so that the outflow unit 1 can be adapted to differently sized and/or differently shaped installation spaces 14. Depending on the installation situation, the individual flexible connecting elements 6 can be cut to different lengths and also have different radii of curvature.

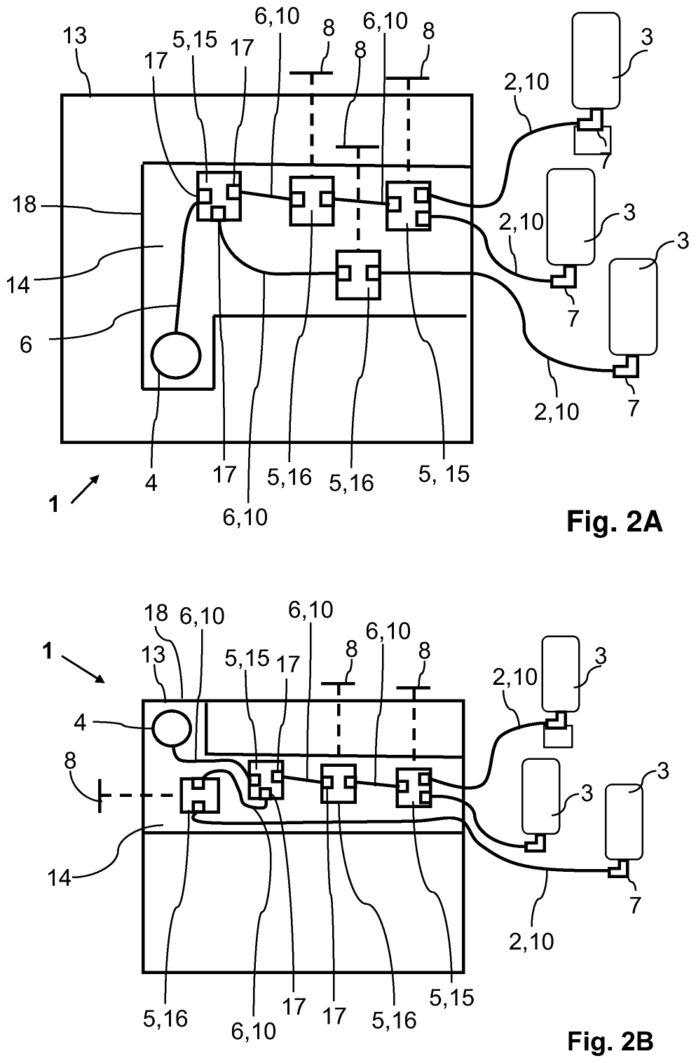

FIGS. 2A and 2B, for example, show two different installation situations of a second possible design of a fluidic outflow unit 1. The different configurations were achieved by simply rearranging the elements 2, 4, 5 and 6, wherein the lengths and radii of curvature of the connecting elements 6 were also adapted (cf. in this regard FIG. 2A with FIG. 2B).

In the example of FIG. 2A, the outflow unit 1 has a total of four fluidic flow control elements 5, wherein only three of which can be controlled via manual operating elements 8. The fourth flow control element 5 is designed as a non-controllable fluidic mixer 15. For this purpose, this mixer 15 comprises two source-side fluidic interfaces 17, which are respectively connected via respective flexible connecting elements 6 to a controllable flow control element 5 which is arranged on the source side. These two interfaces 17 of the mixer 15 issue into an outlet-side interface 17, which in turn is connected to the single outlet element 4 via a further flexible connecting element 6. Thus, the outlet element 4 is fluidically connected to each of the three sources 3 via a flexible connecting element 6.

The two upper sources 3 are connected via the two upper supply lines 2 to a flow control element 5 which is designed as a unifier 15 and which can be switched via a manual operating element 8. For this purpose, the supply lines 2 are designed with connection pieces 7 that enable a plug-in connection to the respective source 3, Depending on the switching state, this flow control element 5 allows the fluid to pass either from the uppermost source 3 or from the middle source 3 and thus functions as a controllable switching valve. The outlet-side interface 17 of this controllable unifier 15 is connected to a further flow control element 5 which is designed as a simple flow valve 16. This is likewise controllable using a separate manual operating element 8, so that the fluid flow from the uppermost or middle source (depending on the switching position of the controllable unifier 15) can be forwarded to the non-controllable mixer 15, which in turn is connected to the outlet element 4.

In FIG. 2A, the lowest source is connected to a further flow control element 5 which is designed as a switchable flow valve 16. Its source-side fluidic interface 17 is connected to the non-switchable mixer 15 via a further connection piece 6. The mixer 15 is configured in such a manner that it always allows both inlet-side fluid flows and thus mixes them. As a result, it is thus possible to dispense from the single outlet element 4 either respectively one of the three different fluids from the three separate sources 3 or a mixture of the fluid from the lowest source 3 with either the fluid from the uppermost or the middle source 3.

This fluidic functionality is also realized by the outflow unit 1 of FIG. 2B, which is functionally identical to the outflow unit 1 of FIG. 2A. However, as can be seen in FIG. 2B, the installation space 14 has changed, which has been compensated for by adapting the geometric arrangement of the elements 2, 4, 5 and 6 and by adapting the length, orientation and curvature of the respective flexible connecting elements 6. This illustrates the high flexibility in the use of an outflow unit 1 in accordance with the invention in different installation spaces 14 of a piece of furniture 13 or, for example, a sanitary object.

If, for example, a flow control element 5 that can be used as a unifier 15 is used in the reverse direction in the outflow unit, this element can be used as a distributor or (actively controllable/manually operable) diverter. Such a diverter can then comprise one source-side fluidic interface 17 and at least two outlet-side fluidic interfaces 17.

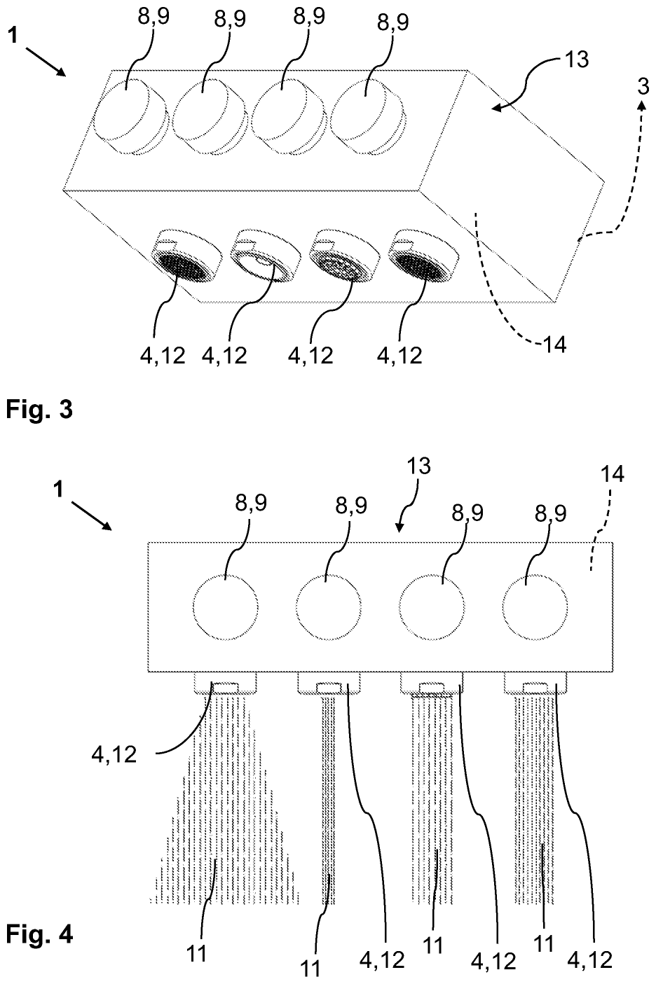

FIG. 3 illustrates that a particularly convenient operation of the outflow unit 1 is made possible when the respective controllable flow control elements 5 are actuated by means of a push-push actuating apparatus 9. In this case, in the example of FIGS. 3 and 4, functionally different jet regulators 12 are provided as respective outlet elements 4, which each form different outlet jets 11 from the respective fluid which is supplied from the source-side (see FIG. 4). In this case, one and the same fluid (or fluid mixture) can be supplied to different ones of the available jet regulators 12 in order to be able to discharge the fluid in the desired jet form. The jet shape can be changed by actuating the respective push-push actuating apparatus 9, which can, for example, actuate a flow valve 16 that releases or blocks the respective fluid flow to the currently selected jet regulator 12.

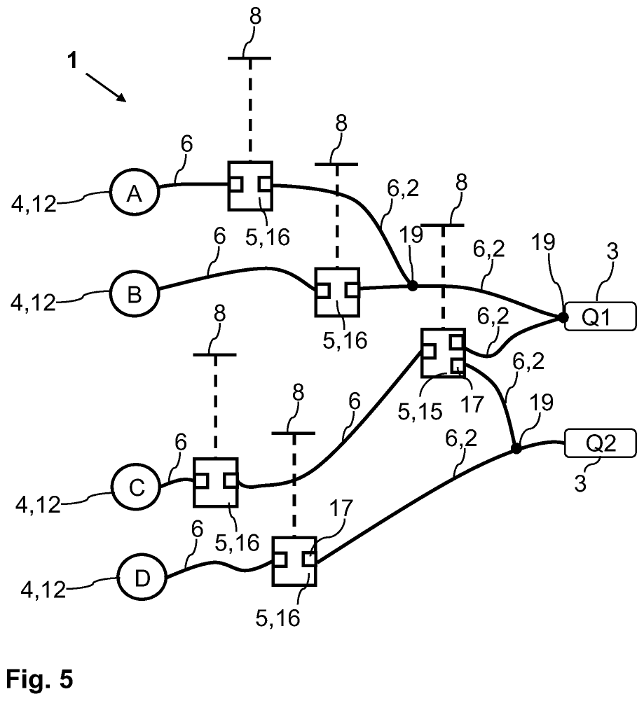

FIG. 5 shows a further outflow unit 1 in accordance with the invention with two connected sources 3 which are designated Q1 and Q2, prior to insertion into an interior space. The fluid flow originating from Q2 is in this case first divided into two branches by means of a fluidic branch 19, each of said two branches runs to a source-side fluidic interface 17 of a respective flow control element 5. The upper branch leads to a mixer 5, while the lower branch leads to a flow valve 16, which supplies the lowest outlet element 4D, which in turn can discharge the fluid from Q2 in pure form.

FIG. 5 shows that a 1:1 correspondence is formed between the outlet elements 4 on the one hand and the associated flow control elements 5 in the form of flow valves 16 on the other.

By means of the switchable mixer 15, the outlet element 4C, which can be switched on or off via a further flow valve 16, can be supplied either with the fluid from Q2 or with a mixture of the fluids from Q1 and Q2 or only with the fluid from Q1 (the mixer 15 thus knows three switching states in this example). Via a further fluidic branch 19 directly at Q1, the fluid from Q1 can be supplied not only to the mixer 15, but also to the two uppermost flow valves 16, which supply the outlet elements 4A and 4B. For this purpose, a further fluidic branch 19 is formed on the connecting element 6, which connects the uppermost flow valve 16 to Q1.

As a result, the fluid from Q1 can be discharged in different jet forms from the outlet elements 4A, 4B and 4C by means of the outflow unit 1—by appropriately actuating the total of five manual control elements 8—as well as a fluid mixture (mixed from the fluids from Q1 and Q2) from the outlet element 4C and finally the fluid from Q2 in different jet forms, either through the outlet element 4C or 4D, which, as already 4A and 4B, respectively form different outlet jets 11 (analogous to FIG. 4).

In summary, in order to simplify the realization of fluidic outflows in a widest variety of application situations, a fluidic outflow unit 1 is proposed which is characterized by the fact that fluid flows from different sources 3 are guided via respective flexible connecting elements 6 to different outlet elements 4 and/or different flow control elements 5 of the outflow unit 1. The use of the flexible connecting elements 6 ensures that the outflow unit 1 can be arranged in different installation spaces 14 inside a piece of furniture 13 or a sanitary object, so that the installation space 14 itself does not need to form any water conduction (cf. FIG. 2A).

### LIST OF REFERENCE NUMERALS

1 Fluidic outflow unit
2 Supply line
3 Source
4 Outlet element
5 Flow control element (for example valve, mixer/unifier)
6 Flexible connecting element (for connecting 4 to 5)
7 Connection piece (for connecting 2 to 3)
8 Manual operating element (for actuating 5)
9 Push-push actuating apparatus (for actuating 5)
10 Hose
11 Outlet jet
12 Jet regulator
13 Piece of furniture (designed for receiving 1)
14 Installation space
15 Unifier/Mixer
16 Flow valve
17 Fluidic interface
18 Wall (of 13, which limits 14)
19 Fluidic branch

1. A fluidic outflow unit (1), comprising:
multiple supply lines (2) which are connectable to respective fluidic sources (3);
at least one outlet element (4);
at least one flow control element (5) for controlling a flow from one of the sources (3) to one of the outlet elements (4); and
at least one connecting element (6) which fluidically connects the at least one outlet element (4) to the at least one flow control element (5), wherein each said supply line (2) is fluidically connected to a respective fluidic source (3) and to at least one respective flow control element (5) and fluidically connects the respective fluidic source and the respective flow control element (5) to one another, and each said flow control element (5) is uniquely assigned one said outlet elements (4).

2. The fluidic outflow unit (1) as claimed in claim 1, wherein at least one of the at least one connecting element (6) or the supply lines (2) is flexible, such that a spatial arrangement of the supply lines, the at least one outlet element, the at least one flow control element, and the at least one connecting element (2, 4, 5, 6) are adaptable in a reversible manner and repeatedly changeable.

3. The fluidic outflow unit (1) as claimed in claim 1, wherein at least one of a) a respective fluid flow is dischargeable from each of the sources (3) as an outlet jet (11) which is formed by the respective one of the outlet elements (4) and is regulatable by an assigned one of the flow control elements (5),
or wherein the outflow unit (1) is adapted to discharge a fluid out of one of the sources (3), via different ones of the outlet elements (4).

4. The fluidic outflow unit (1) as claimed in claim 1, wherein the at least one outlet element (4) at least one of
a) forms an outlet jet (11) which is defined in a jet shape,
b) determines a defined through flow,
c) comprises a defined temperature profile, or
d) draws a fluid from at least one of the sources (3) via a respectively assigned flow control element (5).

5. The fluidic outflow unit (1) as claimed in claim 1, wherein the at least one outlet element (4) at least one of:
a) forms an outlet jet (11) which is defined in a jet shape,
b) determines a defined through flow and
is connected via an assigned one of the flow control elements (5) to at least one of the sources (3), or
c) is arranged by one of the flexible connecting elements (6) respectively which is arranged between the outlet element (4) and the flow control element (5) or between the flow control element (5) and the source (3).

6. The fluidic outflow unit (1) as claimed in claim 1, wherein the at least one flow control element (5) includes multiple flow control elements (5) each of which is at least one of individually controlled or manually operated by a manual operating element (8), and at least one of:
a) in each case a flow of fluid from one of the fluidic sources (3) is regulatable via a respective one of the flow control elements (5), which is assigned to one of the sources, to the outlet element (4),
b) each of the flow control elements (5) is uniquely assigned to one of the outlet elements (4), or
c) two respective fluid flows from two of the sources (3) respectively issue into a common said outlet element (4) or into two separate ones of the outlet elements (4).

7. The fluidic outflow unit (1) as claimed in claim 1, wherein at least two flow control elements (5) of the outflow unit (1) are fluidically connected to one another.

8. The fluidic outflow unit (1) as claimed in claim 1, wherein at least two flow control elements (5) are at least one of manually operable or manually controllable.

9. The fluidic outflow unit (1) as claimed in claim 1, wherein at least one said flow control element (5) is manually switchable by a push-push actuating apparatus (9).

10. The fluidic outflow unit (1) as claimed in claim 1, wherein the at least one outlet element (4) forms a defined outlet jet (11), is formed as a jet regulator (12), or both.

11. The fluidic outflow unit (1) as claimed in claim 1, wherein the at least one outlet element includes at least two functionally different ones of the outlet elements (4).

12. The fluidic outflow unit (1) as claimed in claim 1, wherein the at least one connecting element (6) comprises a flexible hose (10).

13. The fluidic outflow unit (1) as claimed in claim 1, wherein the supply lines (2) are respectively formed as flexible hoses (10).

14. The fluidic outflow unit (1) as claimed in claim 1, wherein the supply lines (2) respectively comprise on a source side a connection piece (7) for connection of the respective supply line (2) to a respective one of the sources (3).

15. The fluidic outflow unit (1) as claimed in claim 1, wherein each of the flow control elements (5) of the outflow unit (1) comprises a source-side and an outlet-side fluidic interface (17) which is couplable or is coupled to one of the flexible connecting elements (6) respectively.

16. The fluidic outflow unit (1) as claimed in claim 15, wherein the interfaces (17) are plugged in a fluidically tight manner into respective ones of the flexible connecting elements (6).

17. The fluidic outflow unit (1) as claimed in claim 1, wherein at least one of a) the at least one flow control element (5) or the at least one outlet element (4) is designed as a unifier (15) or mixer (15) having at least two source-side fluidic interfaces (17) which issue fluidically into an outlet-side fluidic interface (17), or
b) the at least one flow control element (5) is arranged as a unifier having the source-side fluid interface (17) which issues fluidically into two outlet-side fluidic interfaces (17).

18. The fluidic outflow unit (1) as claimed in claim 1, wherein at least one of a) the supply lines, the at least one outlet element, the at least one flow control element, and the at least one connecting element are fluidically connected to one another in a flexible manner such that the outflow unit (1) is adapted to be installed in differently shaped installation spaces (14),
or b) multiple ones of the connecting elements (6) are provided and are flexible, and are configures to at least one of supply or discharge fluid in different spatial directions or comprise different radii of curvature.

19. A piece of furniture (15) or a sanitary object, comprising the fluidic outflow unit (1) according to claim 1,
wherein the outflow unit (1) is inserted in an installation space (14) inside the piece of furniture (13) or the sanitary object,
the at least one outlet element (4) is connected to a source (3) via the at least one connecting element (6), and
the at least one outlet element (4) is inserted into a wall (18) of the piece of furniture (13) or the sanitary object which delimits the installation space (14).

20. A method of discharging fluid, comprising:
providing the outflow unit (1) according to claim 1;
discharging fluids from the outflow unit (1) at different temperatures; and
at least one of a) using at least one of a cooling or heating element of the outflow unit (1) to regulate a fluid temperature or b) providing different temperatures for the fluids at different sources (3).

21. The fluidic outflow unit (1) as claimed in claim 1, further comprising a push-push actuating apparatus (9) for actuating the at least one flow control element (5).
